(19) United States
(12) Patent Application Publication
(10) Pub. No.: US 2012/0158690 A1
(43) Pub. Date: Jun. 21, 2012

(54) SYSTEMS AND METHODS FOR NETWORK SEARCHES INTEGRATED WITH IMAGE SENSOR MODULE

(76) Inventor: Shih-Huang CHEN, Hsin-Chu (TW)

(21) Appl. No.: 13/092,689

(22) Filed: Apr. 22, 2011

(30) Foreign Application Priority Data
Dec. 20, 2010 (TW) 99144701

(51) Int. Cl. G06F 17/30

(52) U.S. Cl. 707/706; 707/E17.108

(57) ABSTRACT

A method for network search integrated with an image sensor module is provided for an electric apparatus. An image is obtained by the image sensor module, wherein the image sensor module is coupled to the electric apparatus. The image is automatically inputted to an input field of a search engine, so as to search the image via a network.

### CROSS REFERENCE TO RELATED APPLICATIONS

This Application claims priority of Taiwan Patent Application No. 099144701, filed on Dec. 20, 2010, the entirety of which is incorporated by reference herein.

### BACKGROUND OF THE INVENTION

1. Field of the Invention

The present invention is related to systems and methods for network searches, and more particularly to systems and methods for network searches integrated with an image sensor module for automatically completing an image scan procedure and corresponding network search.

2. Description of the Related Art

In recent years, with the convenience of electronic apparatuses, such as computers or portable devices, the electronic apparatus has become a necessity of modern day life. In addition, the importance of integration between electronic apparatuses and networks has gradually grown due to the popularity of networks.

For example, a network service provider may provide a search engine to receive a key word provided by a user, and perform a network search according to the received key word. In general, the user must prepare an electronic apparatus (e.g. a computer system) by oneself, and then link to the search engine via the electronic apparatus according to a network address corresponding to the search engine. Next, the user manually inputs a key word to be searched to the search engine for network searches.

In general, the processes that perform the related searches via a network are completed manually, and no scheme is provided to complete the network search automatically. In some cases, if the user wants to search information of specific documents or pictures, the user must conduct additional operations and much time may be used to complete the network searches due to no automatic scheme being provided.

### BRIEF SUMMARY OF THE INVENTION

Systems and methods for network searches integrated with an image sensor module are provided. An embodiment of a method for network searches integrated with an image sensor module is provided for an electronic apparatus. An image is obtained by the image sensor module. The image is automatically inputted to an input field of a search engine, so as to search the image via a network.

Furthermore, an embodiment of a system for network searches is provided. The system comprises an image sensor module and an electronic apparatus coupled to the image sensor module. The image sensor module obtains an image. The electronic apparatus comprises a processing unit, and the processing unit automatically inputs the image to an input field of a search engine after receiving the image, so as to search the image via a network.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a system for network searches according to an embodiment of the invention;

FIG. 2 shows a frame displayed in the display unit according to an embodiment of the invention; and

FIG. 3 shows a method for network searches integrated with an image sensor module, for an electronic apparatus coupled to the image sensor module according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

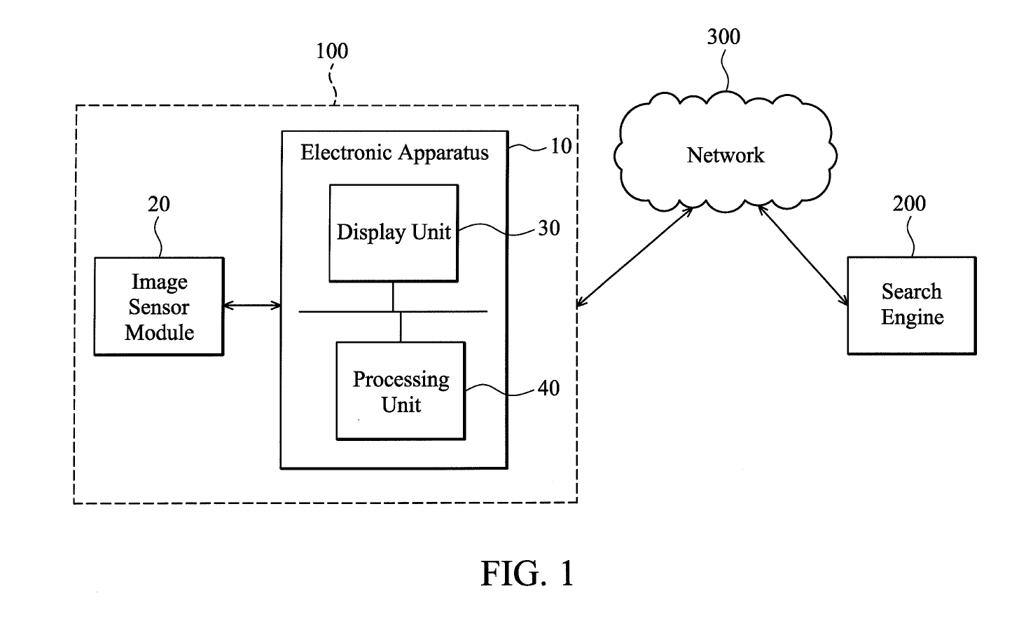

FIG. 1 shows a system 100 for network searches according to an embodiment of the invention. The system 100 is coupled to a search engine 200 via a network 300. The system 100 comprises an electronic apparatus 10 and an image sensor module 20, wherein the image sensor module 20 is coupled to the electronic apparatus 10 with a wireless manner (e.g. Bluetooth (BT)) or a cable manner (e.g. universal serial bus (USB)) for data communications. In FIG. 1, the electronic apparatus 10 may be an electronic apparatus with a processor, such as a computer system and a portable device (e.g. a PDA or a mobile phone), and the image sensor module 20 may be a push type scanner. The image sensor module 20 scans/captures a document or a picture to obtain an image. In some embodiments, the image sensor module 20 may be a contact image sensor module (CISM) for scanning a document to obtain an image. In some embodiments, the image sensor module 20 may be a digital camera for capturing a picture to obtain an image.

In FIG. 1, the electronic apparatus 10 comprises a display unit 30 and a processing unit 40. The display unit 30 is capable of displaying the frames, such as texts, figures, interfaces and so on. It is to be noted that the display unit 30 may be a touch screen in some embodiments, thus, a user may directly perform input and selection operations via the display unit 30.

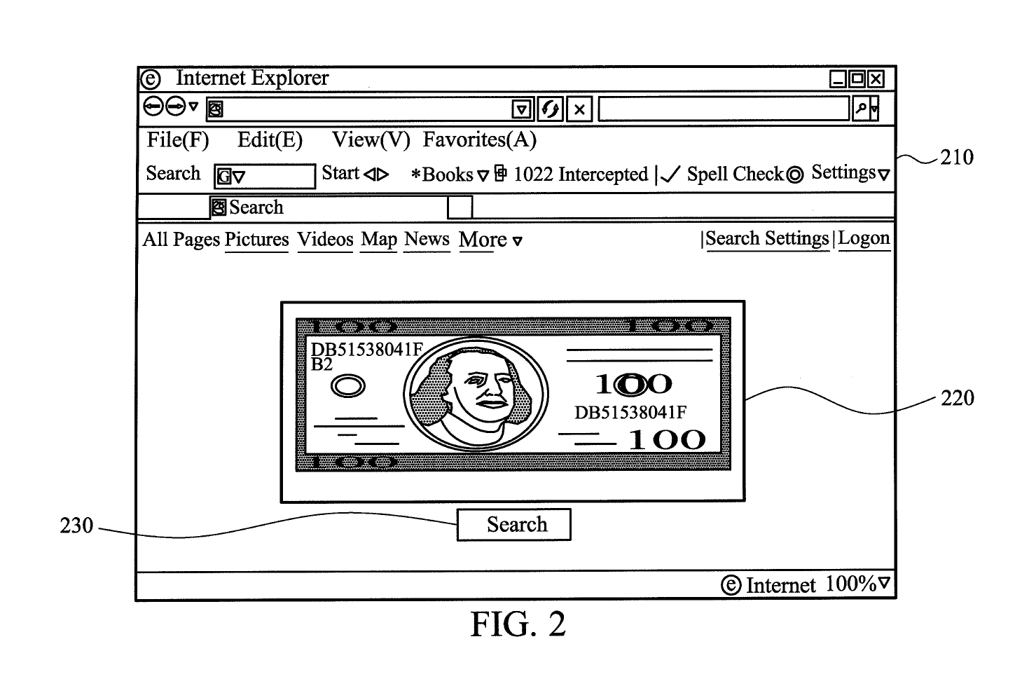

FIG. 2 shows a frame displayed in the display unit according to an embodiment of the invention. Referring to FIG. 1 and FIG. 2 together, when the electronic apparatus 10 receives an image obtained by the image sensor module 20, the electronic apparatus 10 displays an interface 210 of a search engine 200 via the display unit 30, and automatically inputs the received image to an input field 220 of the interface 210. Next, by clicking a search button 230, the received image is searched via the network 300 for a user.

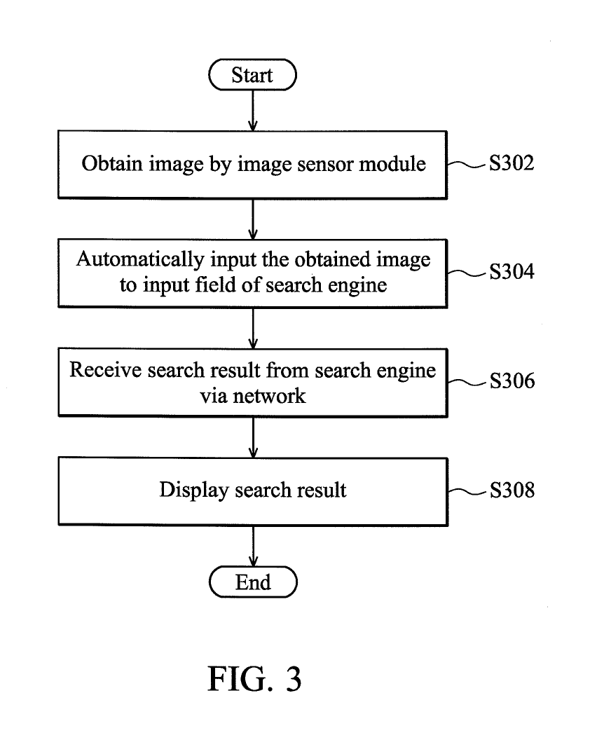

FIG. 3 shows a method for network searches integrated with an image sensor module, for an electronic apparatus coupled to the image sensor module according to an embodiment of the invention. First, in step 5302, an image is obtained by the image sensor module. Similarly, in some embodiments, the image sensor module may scan a document to obtain the image. In some embodiments, the image sensor module may capture a frame to obtain the image. Next, in step S304, after receiving the image from the image sensor module, the electronic apparatus opens and displays an interface of a search engine in a display unit of the electronic apparatus, and the electronic apparatus automatically inputs the obtained image to an input field of the interface. Thereby, a network search is performed in response to the obtained image for a user. In some embodiments, the electronic apparatus records a network address corresponding to the search engine, and connects to the search engine via the network according to the network address. In some embodiments, the search engine may directly use the image to perform a network search and obtain a search result. In some embodiments, the search engine may identify the image to obtain at least one key word from the image and perform a network search according to the key word, so as to obtain a search result which comprises texts, pictures and/or a web page comprising the texts or pictures. Next, in step S306, the electronic apparatus receives the search result provided by the search engine via the network. Next, in step S308, the electronic apparatus displays the search result in the display unit.

In the embodiment, the electronic apparatus transmits the image to the search engine, and then the search engine identifies a key word from the image to perform a network search. Furthermore, in some embodiments, the electronic apparatus may directly identify the key word from the image and transmit the identified key word to the search engine, and then the search engine performs a network search in response to the key word.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for network searches integrated with an image sensor module, for an electronic apparatus, comprising:
obtaining an image by the image sensor module; and
automatically inputting the image to an input field of a search engine, so as to search the image via a network.

2. The method as claimed in claim 1, wherein the image sensor module transmits the image to the electronic apparatus in a wireless communications manner.

3. The method as claimed in claim 1, wherein the image sensor module transmits the image to the electronic apparatus in a cable communications manner.

4. The method as claimed in claim 1, further comprising:
displaying an interface of the search engine by a display unit of the electronic apparatus, and displaying the image in the input field of the interface.

5. The method as claimed in claim 1, further comprising:
identifying at least one key word from the image; and
searching the key word via the internet to obtain a search result.

6. The method as claimed in claim 5, further comprising:
displaying the search result by a display unit of the electronic apparatus, wherein the search result comprises text or picture.

7. The method as claimed in claim 1, further comprising:
identifying at least one key word from the image by the search engine,
wherein the search engine searches the key word and transmits a search result to the electronic apparatus via the network.

8. The method as claimed in claim 7, further comprising:
displaying the search result by a display unit of the electronic apparatus, wherein the search result comprises text or picture.

9. The method as claimed in claim 1, wherein the image sensor module comprises a contact image sensor module (CISM) or a digital camera.

10. The method as claimed in claim 1, wherein the electronic apparatus comprises a computer system or a portable device, and the image sensor module is connected to the electronic apparatus in a wireless or cable manner.

11. A system for network searches, comprising:
an image sensor module, obtaining an image; and
an electronic apparatus coupled to the image sensor module, comprising:
a processing unit, automatically inputting the image to an input field of a search engine after receiving the image, so as to search the image via a network.

12. The system as claimed in claim 11, wherein the image sensor module transmits the image to the electronic apparatus in a wireless communications manner.

13. The system as claimed in claim 11, wherein the image sensor module transmits the image to the electronic apparatus in a cable communications manner.

14. The system as claimed in claim 11, wherein the electronic apparatus further comprises:
a display unit, displaying an interface of the search engine and displaying the image in the input field of the interface.

15. The system as claimed in claim 11, wherein the processing unit further identifies at least one key word from the image and searches the key word via the internet to obtain a search result.

16. The system as claimed in claim 15, wherein the electronic apparatus further comprises:
a display unit, displaying the search result, wherein the search result comprises text or image.

17. The system as claimed in claim 11, wherein the search engine further identifies at least one key word from the image, and searches the keyword and transmits a search result to the electronic apparatus via the network.

18. The system as claimed in claim 17, wherein the electronic apparatus further comprises:
a display unit, displaying the search result, wherein the search result comprises text or image.

19. The system as claimed in claim 11, wherein the image sensor module comprises a contact image sensor module or a digital camera.

20. The system as claimed in claim 11, wherein the electronic apparatus comprises a computer system or a portable device, and the image sensor module is connected to the electronic apparatus in a wireless or cable manner.
